(19) United States
(12) Patent Application Publication
(10) Pub. No.: US 2013/0154194 A1
(43) Pub. Date: Jun. 20, 2013

(54) TURBOCHARGER HOUSING SEAL

(71) Applicant: Daniel J Van Saun, Hendersonville, NC (US)

(72) Inventor: Daniel J Van Saun, Hendersonville, NC (US)

(73) Assignee: BORGWARNER INC., Auburn Hills, MI (US)

(21) Appl. No.: 13/817,921

(22) PCT Filed: Aug. 30, 2011
(86) PCT No.: PCT/US11/49668

§ 371 Date: Feb. 20, 2013

Related U.S. Application Data
(60) Provisional application No. 61/379,873, filed on Sep. 3, 2010.

(51) Int. Cl. F01D 25/24; F02B 39/00

(52) U.S. Cl. CPC F01D 25/24; F02B 39/00
USPC 277/316

(57) ABSTRACT

To prevent escape of exhaust gas and soot from a turbocharger, a heat resistant sealing material is applied to a contact surface between a turbocharger bearing housing and center housing, and cured or dried to form a thin solidified coating. The end housing is then assembled to the bearing housing, whereby the coating provides a gas and soot seal between the bearing housing and end housing. The inventive seal could however also be used to seal the connection between two turbine stages, or any parts attached to a turbocharger end housing and subject to pressure.

### FIELD OF THE INVENTION

This invention addresses the problem of leakage of gas and soot to the atmosphere from a turbocharger, particularly in the area in which the turbine housing or compressor housing is joined to the bearing housing. The inventive seal could however also be used to seal the connection between two turbine stages.

### BACKGROUND OF THE INVENTION

Turbochargers deliver air, at greater density than would be possible in the normally aspirated configuration, to the engine intake, allowing more fuel to be combusted, thus boosting the engine's horsepower without significantly increasing engine weight. A smaller turbocharged engine can replace a normally aspirated engine of a larger physical size, thus reducing the mass and aerodynamic frontal area of a vehicle.

Turbochargers are a type of forced induction system which uses the exhaust flow entering the turbine housing from the engine exhaust manifold to drive a turbine wheel (10), which is located in a turbine housing (2). The turbine wheel is solidly affixed to a shaft to become the shaft-and-wheel assembly. The primary function of the shaft-and-wheel is extracting power from the exhaust gas and using this power to drive the compressor.

The compressor stage consists of a compressor wheel and it's housing (5). The compressor wheel is mounted to a stub shaft end of the shaft-and-wheel assembly and is held in position by the clamp load from a compressor nut. Filtered air is drawn axially into the inlet of the compressor cover by the rotation of the compressor wheel at very high RPM. The turbine stage drives the compressor wheel to produce a combination of static pressure with some residual kinetic energy and heat. The pressurized gas exits the compressor cover through a compressor discharge and is delivered, usually via an intercooler, to the engine intake.

The rotating assembly of the turbocharger is rotatably mounted in a bearing housing (3), and the end housings, i.e., the turbine housing (2) and the compressor housing (5), are attached to the bearing housing assembly.

The end housings are shaped along their circumferential mating surface to be clamped and, under clamping pressure, form a flush fit against a complementary surface of the bearing housing. The radial alignment of the end housings to the bearing housing is typically managed by a complementary pair of machined diametral pilots, either turned or milled into both the bearing housing and the aforementioned end housings. The axial alignment and attachment of either end housing is managed typically by one of two methods.

A first method of attachment of the end housing to the bearing housing is by vee bands (40). \Tee bands are formed stainless steel bands with retainer sections (41) formed in the shape of a vee. The retainers (41) are mounted on a band (42). The retainer can be one piece or multiple pieces. The vee-band typically consists of: the band (42) with retainer (41); a tee-bolt (43) with a threaded post on one end of the band; and a trunnion (44) attached on the opposing end of the band. When assembled, the threaded post of the tee bolt is passed through the trunnion. Threading a nut (45) onto the threaded post and tightening the nut draws the opposing ends of the vee-band together. The vee-band engages a pair of tapered “half flanges” (20, 30) which, when placed together, combine to form a “whole” flange generally triangular in cross-section. Each “half flange” extends out from the respective housing part captured by the vee-band. In FIG. 3A, the left side includes a bearing housing “half flange” (30), and the right side includes a turbine housing “half flange” (20). By tightening the nut on the vee-band, the vee-band circumference is reduced and the circumferential force is translated to an axial force by a wedging action, drawing the two halves together and creating, at least in theory, a seal.

The radial alignment, and the ability to be rotated with respect to one another (for orientation), of the two parts drawn together by the vee-band is accomplished typically with a diametral recess cut into one part and a male protrusion fabricated into the other part. In FIG. 3A, the bearing housing is machined to produce a positive protrusion (31) which fits into a complementary recess cut into the turbine housing.

The second method of attachment of the end housings to the bearing housing is by a combination of clamp-plates with bolts as depicted in FIG. 4. In this configuration, holes are tapped in the housing, and bolts (36) are inserted into the tapped holes, trapping a clamp plate (35) which then imparts the clamping force to the joint between the bearing housing and the end housing. As depicted in FIG. 4, a pilot flange (30) fits into a complementary recess, thus radially locating the bearing housing co-axially with the bore in the turbine housing (2).

While this is an effective method for retaining the bearing housing on the turbine housing (most engine installations assemble the turbine housing to the engine manifold, and the remainder of the turbocharger hangs off the turbine housing requiring this joint to support an overhung mass), it is quite difficult to retain an appropriate clamp load across a broad temperature spectrum, each component in the assembly having a different coefficient of expansion, yield strength, elongation, and fatigue characteristic over this disparate temperature range. Because of this complication, the sealing capability of this joint is often compromised, which may pose a problem considering the pressure differences between the turbocharger interior spaces and the atmosphere.

A comparison between methods of axial clamping reveals that for two similar sized turbochargers, one in which the turbine housing is mounted to the bearing housing with a vee band, and the other in which the turbine housing is mounted to the bearing housing with bolts and clamp plates, the clamp plate connection has an axial capacity of 51,000N, and the vee-band connection has an axial capacity of 30,000N at ambient temperature.

The temperature spread between components in the turbine housing to bearing housing joint interface can be quite wide. Exhaust gas can be in excess of 760° C. to 1100° C., depending on fuel type and engine type. The clamping face of the turbine housing to bearing housing joint is often only a matter of a few millimeters from this exhaust gas, so the hot side of the joint can be as much as 500° C. to 600° C. hotter than the material temperature of the mating part of the bearing housing.

In practice, either or both methods are employed for attaching the end housings to the bearing housing. It is not unusual to see turbine housings mounted to the bearing housing with clamp plates and bolts, and compressor housings mounted to the bearing housing with vee-bands. The method of mounting is determined by many factors, some being:
The axial space on the engine allocated for the turbocharger. Vee-band connections typically require more axial length than do clamp-plates-and-bolted connections.
The method of manufacture (housings are sometimes predominantly machined by turning, and sometimes by milling): turning makes the machining of a flange cost-effective; milling makes the drilling and tapping of bolt holes economical. Typically vee-bands are more expensive than clamp-plates-and-bolts, but the machining costs are the opposite, so the “total manufacturing cost” often becomes the driver.
The need to allow the engine customer to alter the orientation of one or both end housings to the bearing housing, so that the end housing's inlet or discharge ports align with mating features on the engine or vehicle. This need is driven by the requirement to have a minimum of turbocharger part numbers, coupled with the situation in which one basic turbocharger is used on multiple engine/vehicle configurations.

All OE turbochargers must meet burst and containment requirements for liability reasons. Vee-bands have to be allowed to spread open to absorb the axial loads imparted on the joint by the burst activity. With bolts and clamps, the clamp has to bend some and the bolt/thread combination has to yield some in order to meet the requirement.

In addition to providing mechanical attachment, the joint between the end housing and the bearing housing must also be able to contain exhaust components such as exhaust gas and soot within the turbocharger thus preventing escape of said combustion products. Because the joint of bearing housing to end housing is often towards the radial periphery of the turbocharger, the end-housing-to-bearing-housing joint diameter is relatively large so any deflections caused by vibration of the turbocharger, vibration of the engine, and deflections due to the inertia of the turbocharger resisting movement of the vehicle manifest themselves over a considerable distance and cause this pair of mating surfaces to be poor seals. There are clamping criteria to be met with this joint so to met these criteria these interfaces are often treated with anti-seize (in paste or liquid form). The anti-seize also helps in aiding the rotation of the end housing to the bearing housing for orientation. Once exhaust gas blows through the joint, the anti-seize compound is blown out of the joint into the engine bay.

In today's emissions environment, the turbocharger is not permitted to pass any gas or soot to the engine compartment ambient environment other than through the exhaust system. To pass gas or soot through joints in the turbocharger means that these leaked materials do not pass through any exhaust after-treatment, so are not emissions controlled. Leaked exhaust gas can seep into the driver cabin and be dangerous to the vehicle driver. Leaked soot is detrimental to the aesthetics of the engine compartment. So, many engine manufacturers have qualification standards which do not allow any escape of gas or soot from the turbocharger other than at the typical turbocharger-to-vehicle ducting, for example from the turbine housing to the exhaust pipe.

Turbocharger designs typically employ turbine heat shields (80) to limit the heat flow from the turbine gases and the turbine wheel to the bearing housing. The typical turbine heat shield, as depicted in FIGS. 2A and 2B, is a cupped metal stamping or sometimes a machined metal part. In high volume manufacture, the turbine heat shield is stamped from stainless steel sheet. The turbine side face of the turbine heat shield is in close proximity to the backside of the turbine wheel as can be seen in FIG. 1, which means that the turbine heat shield is subject to radiative heat from the turbine wheel in addition to the conductive effect of exhaust gas impinging on the material of the turbine heat shield. The temperature at the clamping faces (84_{C} and 84_{T}) of the turbine heat shield are a product of the radiated and conducted heat absorbed in the main body of the turbine heat shield, less what thermal energy is conducted away from the heat shield by contact with the turbine housing on the turbine side and the bearing housing on the bearing housing side.

The pressure gradients between turbine housing and bearing housing and between compressor housing and bearing housing represent a dynamic system which is driven by not only turbocharger rotational speed, but also load factors pertaining to the engine. Gas passage from the bearing housing, to the turbine housing, and vice versa, are predominantly controlled by a turbine-end piston ring (78), which is mounted in a groove in the rotating shaft-and-wheel and seals against the static bearing housing bore (32) and the rotating cheeks of the piston ring groove.

There is also a gas passage to the ambient environment external to the turbocharger through the small openings which are inevitable due to material roughness and machining variations between the clamping surfaces (22) of the turbine housing to the turbine-side surface (84_{T}) of turbine heat shield and the compressor-side surface (84_{C}) of the turbine heat shield and the bearing housing surface (33). Materials (gases and soot) which pass through this sealing interface can escape through the path (90) formed by the adjacent faces of the bearing housing and the turbine housing, through the vee band, and into the engine bay. Because the vee band requires 360° of contact and sufficient axial clearance (in order for there to be space for the vee band), the radius of the vee band flange is typically close to, or greater than, the maximum radius of the volute from the turbocharger center line. Thus, the surface area of each of the adjacent faces from roughly the outside diameter (82) of the turbine heat shield to the maximum diameter of the vee-band flange (34) is of the order of 4 times that of the diameter of the turbine heat shield.

One approach for preventing this gas and soot leakage is seen in U.S. Pat. No. 6,415,846, Steve O'Hara, which denies the leakage of gas and soot to the ambient environment by having no mechanical joints between turbine housing and bearing housing, since the turbine housing and bearing housing are cast as a single part. However, such unitary castings do not allow the engine customer to alter the orientation of one or both end housings to the bearing housing, to allow alignment of the end housing's inlet or discharge ports with mating features on any given engine or vehicle configuration. Thus, a different mold would have to be created for every different vehicle configuration.

Many solutions to this problem of preventing the escape of exhaust gases and soot from the turbocharger to the ambient environment require additional components, such as seal rings or graphite impregnated seals, to generate an effective seal. The addition of another component represents additional parts, potential failure points and labor and handling costs for the manufacturer.

So it can be seen that there exists a need for a better seal for the joint of the end housings, particularly the turbine housing, to bearing housing.

### SUMMARY OF THE INVENTION

The present invention relates to a method for preventing escape of exhaust gas and soot from a turbocharger, and accomplishes this by the design and implementation of a pre-applied cured or dried coating to existing parts to generate a gas and soot seal between the bearing housing and end housing, and particularly the turbine housing, of a turbocharger.

It is well known that the turbocharger turbine housing is not only exposed to exhaust gas at very high temperatures, but also connected to the engine exhaust manifold, and that the compressor housing in contrast is exposed to feed air at much cooler temperatures, and that the bearing housing is a metal heat conductor bridging the two end housings. Further, as the turbine housing is heated by the exhaust gas, the turbine housing heats non-uniformly, causing thermally induced deformation. Thus, the means for connecting the turbine housing to the bearing housing are designed to allow a slight amount of both axial and radial sliding contact. Those working in this art thus assume that the metal contact surfaces be kept clean and able to slide. It is surprising that, in accordance with the present invention, a suitable sealing material applied on one contact surface, and dried or cured to form a coating before the assembly of the end housings to the bearing housing, will remain in place to effectively seal the exhaust leak gap.

The dried or cured coating is preferably formed at the contact areas of a heat shield rather than the bearing housing or end housing. A heat shield, being comparatively light-weight and having low mass, is easily dried or cured in an oven. Such a coating modified heat shield can be handled the same way as any conventional heat shield during assembly of the turbocharger, thus introducing no change to the assembly line.

### BRIEF DESCRIPTION OF THE DRAWINGS

The present invention is illustrated by way of example and not limitation in the accompanying drawings in which like reference numbers indicate similar parts, and in which:

FIG. 1 depicts a section of a typical turbocharger assembly;

FIGS. 2A,B depict two views of a typical turbine heat shield with dry sealant applied;

FIGS. 3A, B depict two views of a typical vee-band;

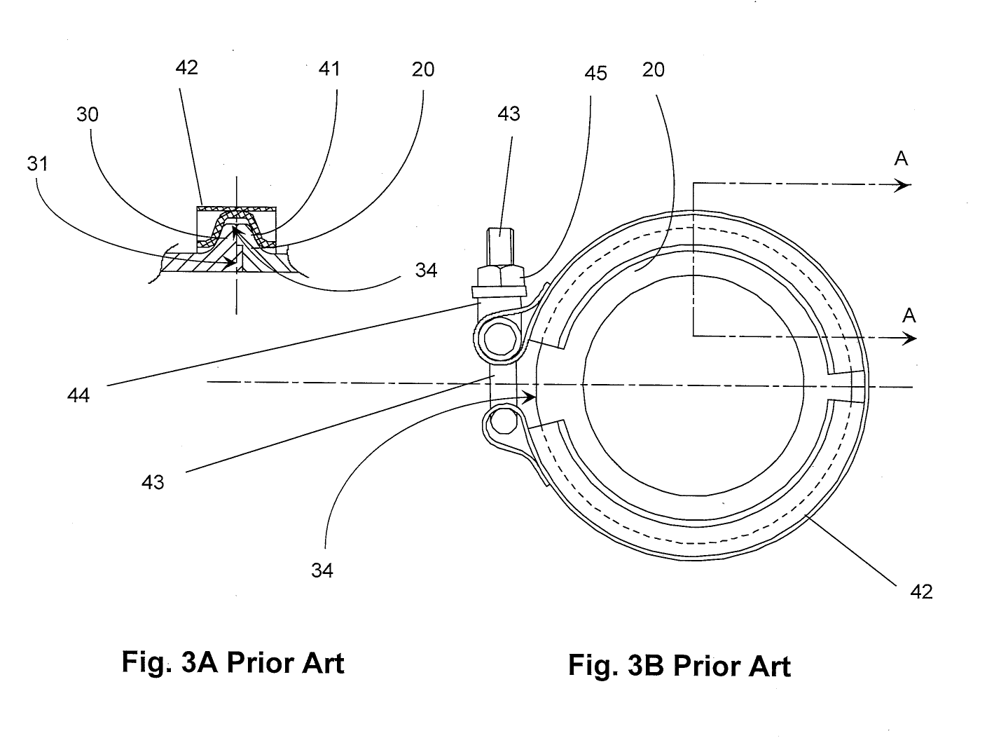

FIG. 4 depicts the geometry of a typical bolt plus clap plate joint;

FIG. 5 depicts the geometry of a typical vee-band joint; and

FIG. 6 depicts a multi-stage turbocharger configuration.

### DETAILED DESCRIPTION OF THE INVENTION

The inventors realized that microscopic faults and machining imperfections presented an opportunity for exhaust gas or compressed air leak at the clamping surfaces or sealing interface between the end housing and bearing housing, but there existed a high degree of difficulty in sealing either a vee-band connection, at a relatively large radius from the turbocharger centerline, or a clamp-plate-and-bolt connection, at a lesser diameter, without introducing a separate gasket to effect a seal. Due to the thickness of such a gasket; the extra steps involved in introducing such a gasket during turbocharger assembly; and the fact that gaskets tend to relax with thermal cycling, this approach has been associated with problems and has not been broadly adopted industrially.

The present inventors devised a method for sealing involving: (a) identifying complementary contact surfaces between a bearing housing and an end housing between which, e.g., in the case of the turbine end, exhaust gas and soot may escape during turbocharger operation; and (b) applying a sealing material to at least one of said complementary surfaces; (c) curing the sealing material to form a part with a dry or cured coating; and (d) assembling the turbocharger such that the coating forms a barrier to the escape of exhaust gas and soot.

Considering the universe of potential sealing materials from which to select to generate a gas and soot seal between, e.g., the bearing housing and turbine housing of a turbocharger, it is necessary that the selected sealing material have certain physical and chemical properties, including ability to tolerate the high temperatures associated with turbine housings of turbochargers and the ability to survive repeated cycles of differential thermal expansion between adjacent parts being heated and cooled at different rates and having different thermal coefficients of expansion Sealing materials in general can be grouped into “flowable”, “shaped insert”, and “pre-solidified”.

Flowable Sealing Materials

Sealing materials (“sealants”) are known which are applied in flowable form (liquid, gel, paste, etc.—a form which flows at room temperature) and which are designed to be in this flowable form at least at the time the opposing surfaces to be sealed are brought together. This includes water based sealing materials and polymer type sealing materials.

Such sealants are commonly applied to exhaust pipe gaskets, catalytic converters, gas turbine engines or fuel cells in flowable form and the parts are joined under pressure (clamped, bolted), after which the sealant is dried or cured, usually by baking in an oven or by “running in” the part under controlled conditions.

The flowable type sealing material is however associated with certain problems. Adding a station to an assembly line to apply a flowable sealing material to either, or both, the bearing housing and turbine housing, represents additional investment in capital and manpower. Ensuring that the sealing material is applied evenly, without bubbles or voids, and that the flowable sealant is not rubbed off or wiped off by contact in the assembly process, may require extensive quality control equipment. Further, the limited exposure time of the material prior to drying of water based sealants or curing of polymer based sealant presents problems of urgency, and such parts may scale or cure between shifts or if left overnight. It is often necessary to control the atmosphere and temperature to prevent drying or curing of such parts. Finally, in the event that the sealing material is designed to be dried or cured after the parts are joined, this would represent significant time and energy requirements, as it requires much energy to heat a turbocharger housing to a curing or drying temperature.

Shaped Insert

A separate insert made of a solid material, for example, a graphite gasket, an O-ring, a copper laminate gasket, etc, which may optionally have one or both sealing surfaces coated with a further sealant material, may be used to form a seal. However, such an additional part also introduces new design problems, durability considerations, and assembly costs, and thus could not come into consideration as an optimal method for sealing leaks in a turbocharger.

Pre-Solidified Sealing Material

To side-step the problems associated with the flowable sealing materials and the shaped inserts, the inventors experimented with applying to at least one contact surface a thin layer of a flowable but solidifiable sealant, and drying or curing the sealant in place to form a solid coating prior to the time of mating the contact surfaces, so that the solidified coating is on at least one part otherwise conventional part of the turbocharger as delivered to the assembly station. Such coatings are relatively easily applied (e.g., sprayed, silk screened, brushed), do not run since they are thinly coated and dried or cured in place under controlled conditions. They are not easily removed (in fact, they can be difficult to remove). The solidified sealants used in accordance with the present invention are characterized by resistance to high-temperature aging, resistance to corrosive atmosphere, resistance to sulfuric and nitric acid, and resistance to oils and other hydrocarbons. Sealants that are conventionally used in similar extreme high temperature applications, such as automotive exhaust gasket coating materials, can be considered as suitable candidates for use in accordance with the present invention, the present invention differing from the conventional methodology in that the sealing material is dried or cured prior to joining the parts, whereas the conventional method for sealing an exhaust pipe gasket involves applying sealant and then joining the parts with clamping pressure squeezing against the flowable sealant.

Sealants can be based on various main ingredients such as molybdenum disulfide (MoS₂), graphite, or versions of fluoropolymers, e.g., fluoroplastics or fluoroelastomers. Sealing materials which are effective at temperatures in excess of 500° C. can be found in the catalogs of various manufacturers or distributors of sealing materials. The exact composition of the sealant is not important; what is important is that the sealant be of the type that can be pre-applied to, e.g., the heat shield, and cured in place to form a solid coating, and that the sealant remains effective and endures temperatures ranging from at least 550° C. to 600° C.

For greater convenience, and to avoid precautions such as exclusion of light, and also the avoid the cost and hassle of additional equipment associated with UV curing, light curing, or electron beam curing sealants, the common and commercially readily available sealants are preferably used in the present invention.

In one preferred embodiment of the invention, a 0.5 to 1.2 mm thick (in the dry or cured state) coating of “Sandstrom L277” MoS²/Graphite material (a water based, spray applied material with a 40% solids content comprising 5-10 wt. % silicic acid sodium salt, 20-25 wt. % molebdynum disulphide, 1-5 wt. % carbon, and balance water) is applied to both “half flange” contacting surfaces of the heat shield (84_{T} and 84_{C}) and dried, preferably in a heated dry atmosphere, preferably under circulating air at 60-150° C. for 15 minutes, after which the coated part is allowed to cool in moving air for 15 minutes. The thus coated part can be handled without fear of rubbing off of the coating.

The high-temperature sealant could also be an adhesive type material as disclosed in U.S. Pat. Nos. 6,648,597 or 7,150,099, i.e., a high temperature ceramic adhesive such as obtainable from Cotronics Corporation, of Brooklyn, N.Y. (particularly those products sold under the product labels 907F, 7020, 954, 952, 7032, Resbond 989 or 904); Aremco (Ceramabond 503, 600, or 516), Sauerizon (phosphate based adhesives), or Zircar (ZR-COM) or variations on these basic adhesive types. However, in accordance with the present invention, the material is applied to a surface and dried or cured prior to, not after, assembly of the turbocharger.

Alternatively, one could use products from Unifrax Corporation, of Niagara Falls, N.Y., sold under the trademarks UNIFRAX LDS, FIBERMAX CAULK, or TOPCOAT 3000. Other alternatives include Hercules High-Heat Furnace Cement #35-515, available from Hercules Inc., and Rutland 477/78 Stove Gasket Cement.

It is desirable that the sealant have a coefficient of thermal expansion that is approximately the same as that of the turbocharger housing and heat seal material. By “approximately the same” it is meant that the coefficients of thermal expansion of the two materials be within about 25% of each other. In general, the more closely matched the coefficients of expansion, the better. With operating temperatures of the order of 500° C., the matching of the coefficients of expansion is clearly important in promoting the long-term durability of the seal. The coefficient of thermal expansion of the sealant can be adjusted by mixing the sealant with small particles of metal, or with metal powders. In the case that the sealant materials are primarily ceramic, such materials have a much lower coefficient of expansion than that of the metal particles. Mixing the metal particles or powder with the ceramic can therefore yield a product having a coefficient of expansion that approximates the coefficient for the heat shield or turbocharger housing.

Finally, New Pyro-Putty 950, a high temperature and high pressure resistant sealant developed by Aremco Products, Inc., is intended for use as a replacement for gaskets and to repair rough, scored or irregular surfaces for sealing high temperature components such as boilers, compressors, heat exchangers, furnaces, ovens, exhaust manifolds, and turbines for service conditions up to 510° C. The manufacturer teaches that a joint can be cured by heating to 204° C. for 1 hour. However, in contrast to the manufacturer's instructions, in the present invention the sealant is applied in a thin layer and cured prior to forming of the joint.

### Preferred Embodiments of the Invention

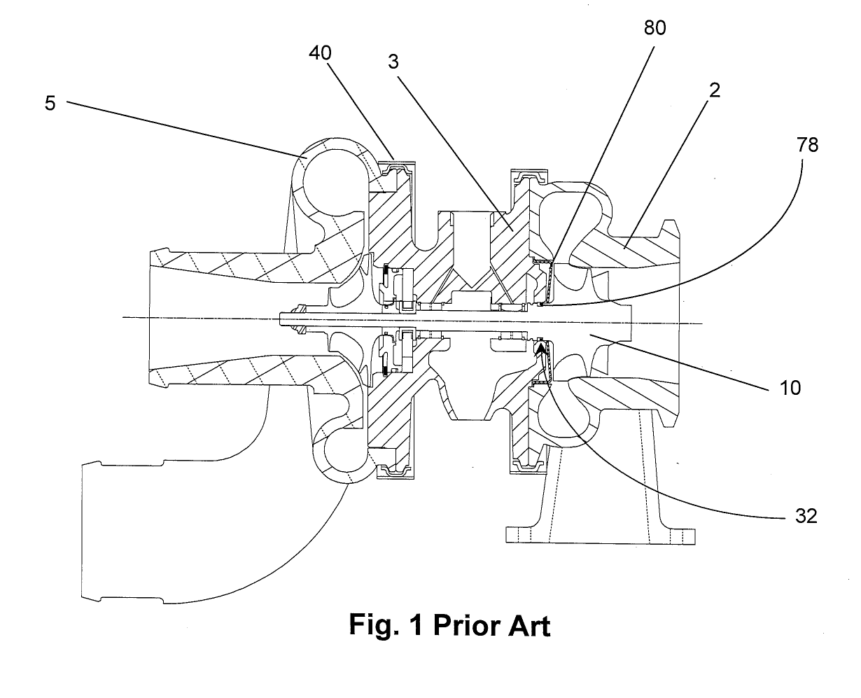

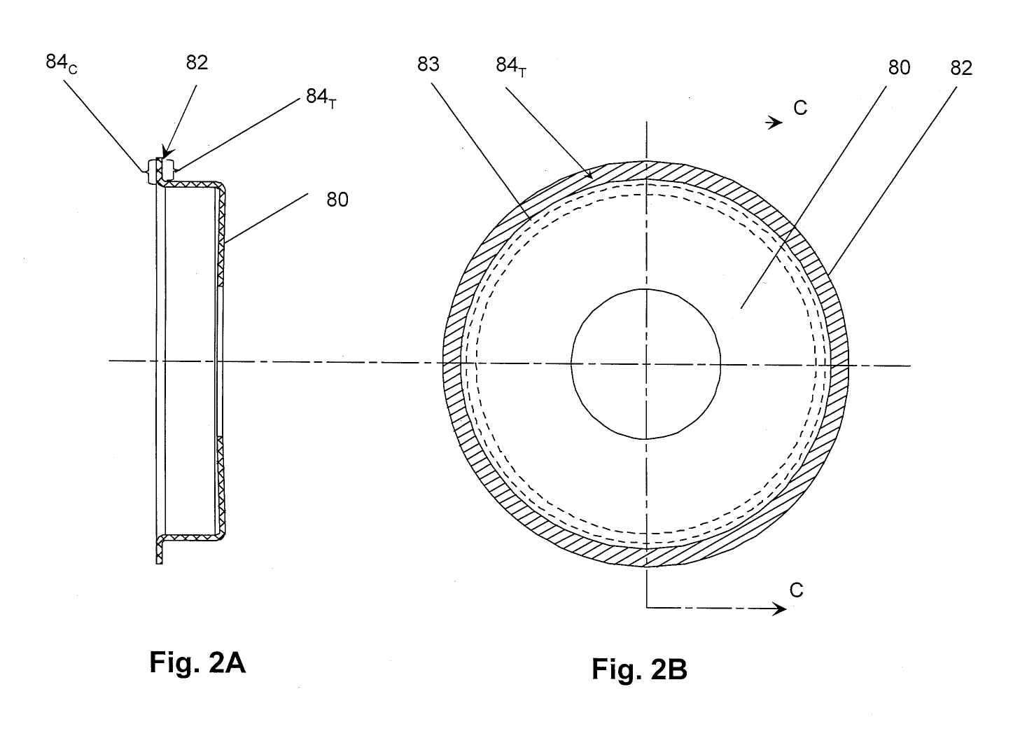

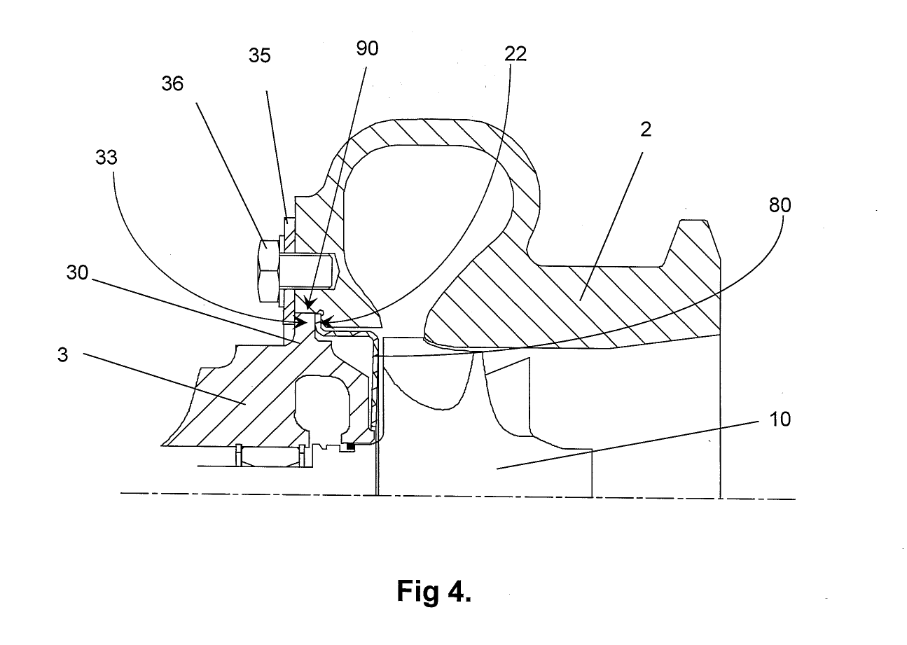

As depicted in FIGS. 2A and 2B, a typical turbine heat shield (80) is drawn and stamped from stainless steel sheet stock. Of course, the heat shield could be rolled, or even machined from solid, and could assume a variety of shapes from very shallow stamping to ribbed. The flange of the heat shield has an outer diameter (82), which locates in either a recess in the bearing housing or turbine housing, to locate the heat shield concentric relative to the turbocharger. In the case depicted in FIG. 4, the recess is in the turbine housing, and the bearing housing has a pilot diameter which also radially aligns in this recess. The location of pilot and recess could just as well be reversed. A hole is stamped in the center of the heat shield to allow the shaft-and-wheel to pass through the heat shield. Thus there is an annulus between the shaft-and-wheel and the heat shield, enabling exhaust gas and soot to pass through the hole in the heat shield. On the shaft-and-wheel assembly is mounted a piston ring (78) which seals on its cheek faces with the piston ring groove in the shaft-and-wheel and seals on its outer diameter with the piston ring bore (32) in the bearing housing as depicted in FIG. 1. The piston ring seal prevents flow of exhaust gas and soot from the turbine wheel side of the piston ring to the bearing housing side of the piston ring.

In the absence of the present invention, this exhaust gas and soot, which can be under pressure in the space on the bearing housing side of the heat shield, can escape the inner part of the turbocharger though a leak path formed between the heat shield compressor facing flange surface (84_{C}) and the turbine facing pilot surface (33) of the bearing housing.

The exhaust gas and soot can also escape to the ambient environment through the space on the turbine housing side of the heat shield. The leak path is through the joint formed between the heat shield turbine facing flange surface (84_{T}) and the compressor facing pilot surface (22) of the turbine housing, and then through the gaps between the clamp-plates to ambient atmosphere.

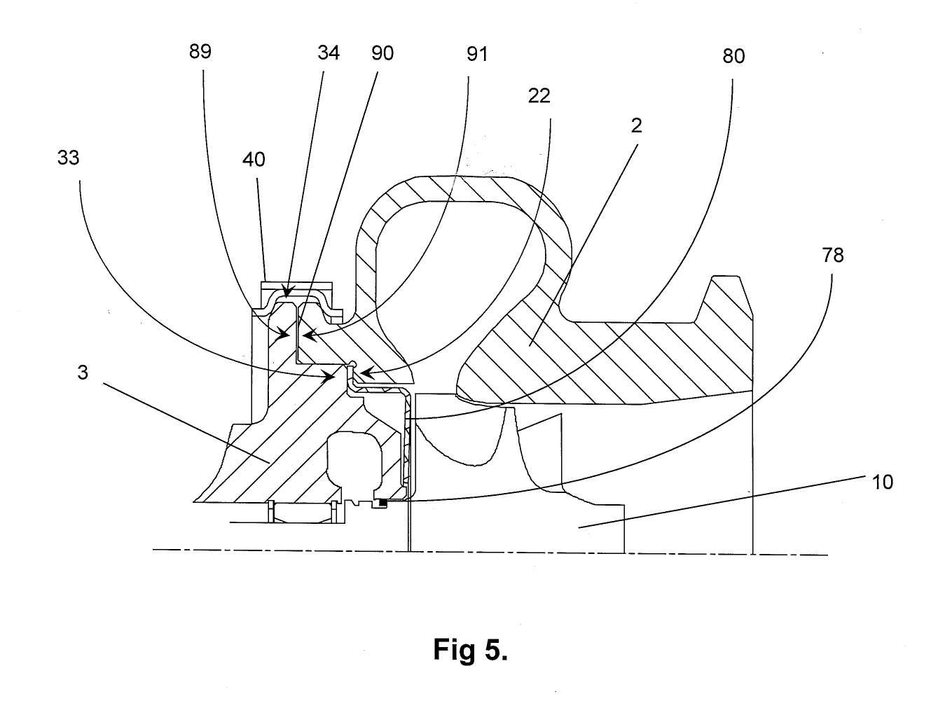

In a vee-band configuration, as depicted in FIG. 5, the design tolerances in the bearing housing and turbine housing are typically determined so that when the axially facing adjacent contact surfaces (22, 33) of the turbine housing (2) and the bearing housing (3) are clamped against the flange of the heat shield, there remains a gap (90) between the diametrically outer compressor facing surface (91) of the turbine housing (2), and the diametrically outer turbine facing surface (89) of the bearing housing (3) (i.e., between the outside diameters of the vee-band flanges (34) and approximately the outside diameter of the heat shield).

In a clamp-plate-and-bolted type connection, as depicted in FIG. 4, the sum of the thickness of the flange (30) of the bearing housing (3) and the thickness of the flange of the heat shield is typically greater than the depth of the recess in the turbine housing to allow the bolt (36) to deflect the clamp plate (35) in order to apply a clamping load at both the contact of the bearing housing (3) to the turbine housing (2) and the contact of the bearing housing (3) to heat shield (80) to turbine housing (2).

In either configuration, clamp-plates-and-bolts or vee-band, the surface imperfections at the contact surfaces can form leak paths allowing leakage of gas or soot. Once through either of these two leak paths (90) as depicted in FIGS. 4 and 5, the gas and soot can enter the ambient environment.

In accordance with the present invention, the sealant which is applied and solidified (dried or cured) to form a solid coating in the contact areas prior to assembly of the turbocharger prevents this leakage.

In the first embodiment of the invention, sealant material is pre-applied as a thin layer to both the compressor facing surface (84_{C}), and the turbine facing surface (84_{T}) of the flanges of the turbine heat shield (80). The surfaces to be coated are the two surfaces bounded by the outside diameter of the turbine heat shield (82) and the radii connecting the flange to the generally cylindrical wall surfaces connecting the flange to the slightly conical surface adjacent to the turbine wheel. The thin layer of sealing material is then cured or dried to form a solidified coating layer. When assembled while building a turbocharger, the compressor facing surface (84_{C}) is constrained by the turbine facing surface (33) of the bearing housing, and the turbine facing surface (84_{T}) is constrained by the compressor facing surface (22) of the turbine housing.

Since the sealing composition is pre-dried or cured, the parts are not sensitive to touch, can be easily inspected for coating consistency, can be reprocessed in the case defects are noted, are easy to handle, and do not run. Thus, turbocharger assembly can proceed in a conventional manner without requiring special precautions or training. Further, in accordance with the present invention, since the coating is a dry solid coating, turbocharger parts can be serviced, e.g., disassembled and reassembled, without breaking or damaging the seal.

Testing by the inventor to measure the effectiveness of the inventive sealing protocol showed that a turbocharger in the uncoated heat shield configuration, with compressor inlet and turbine outlet sealed, pumped up to 2.7 atmospheres, lost 50% of the test pressure in less than 2 minutes, while testing of a similarly configured turbocharger with the pre-applied dry coated heat shield showed that no test pieces leaked down to 50% of the test pressure after 10 minutes, even in turbochargers which went through multiple dis-assembly and re-assembly of the heat shield.

In a second embodiment of the invention, for a water cooled turbine housing, or a turbocharger which does not use a typical turbine heat shield, the sealing material is applied, and dried or cured to form a solid coating prior to assembly, to one or both of the direct contact surfaces of turbine housing to bearing housing. As an example: for a clamp-plate-and-bolted configuration, the sealant would be applied to the compressor facing surface (22) of the abutment in the recess in the turbine housing and to the turbine facing surface (33) of the flange (30) of the bearing housing and then dried or cured. In this case, there would be no turbine heat shield in this joint, so the two faces of the two housings would be in contact, thus forming a sealing surface. A seal, albeit a less efficient seal, could also be formed by pre-applying the coating to any other complementary adjacent surface or surfaces along the leak path (90).

In an alternative to the second embodiment of the invention, for a water cooled turbine housing, or a turbocharger which does not use a turbine heat shield, the dry coating is applied prior to assembly to the direct interfaces of turbine housing to bearing housing. As an example: for a vee-band configuration, the sealant would be applied to the compressor facing surface (22) of the abutment in the recess in the turbine housing and to the turbine facing surface (33) of the flange (30) of the bearing housing and then dried or cured prior to assembly. In this case, there would be no turbine heat shield in this joint, so the two faces would be in contact and thus form a sealing surface. A seal, albeit a less efficient seal, could also be formed by pre-applying the dry coating to any other complementary adjacent surfaces along the leak path (90). In some cases, for vee-band configurations, the outer complementary adjacent faces (33, 91) are relieved so as to ensure sufficient clamp load at the primary inner interface (22, 33) of the pilot and recess as explained above. In the case for a relieved pair of surfaces, or a singularly relieved surface, this zone would no longer be applicable for a pre-applied and dried or cured coating.

In a third embodiment of the invention, in a configuration in which there are multiple turbochargers, such as series or regulated two stage turbochargers, a coating is applied to the complementary adjacent surfaces of the slip joint and then cured or dried prior to assembly to a configuration joining the turbochargers to the turbine duct carrying the exhaust from the exducer of first turbine stage to the inlet of the second turbine stage. In a configuration in which there is a slip joint where the turbine duct slips into or over the downstream turbine stage, then the pre-applied and cured or dried coating would be applied to the complementary adjacent surface of that slip joint.

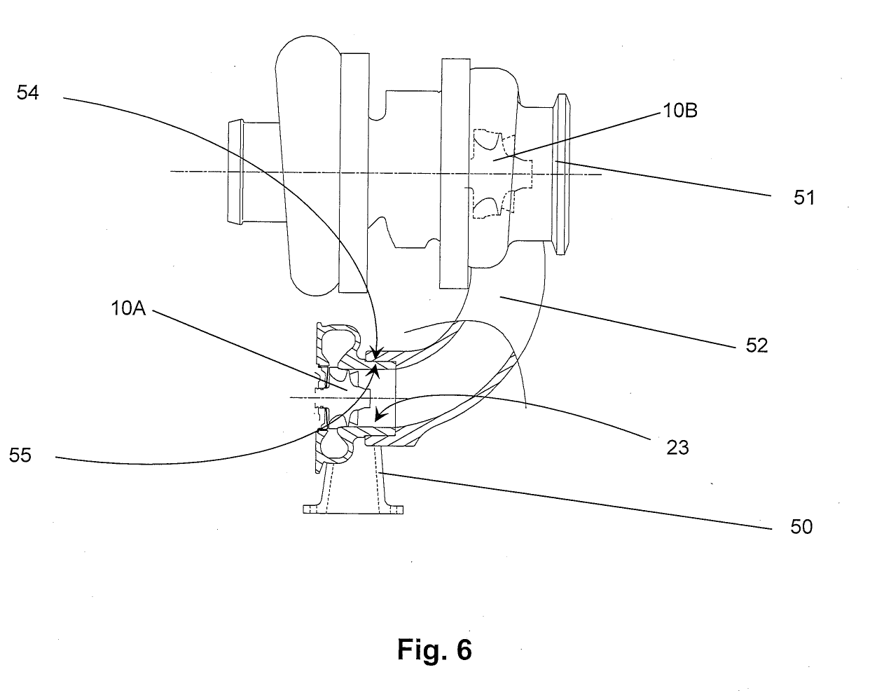

As depicted in FIG. 6, a first stage turbocharger has a turbine housing (50) from which exhaust gas exits the turbine wheel (10A) through the exducer (23) and flows out of the first stage turbine housing (50) into a turbine duct (52). The turbine duct (52) fluidly connects from the exducer (23) of the first stage turbine housing to the entry of the second stage turbine housing (51) where it directs the exhaust gas from the first stage exducer (23) to the turbine wheel (10B) of the second stage turbocharger. The turbine duct has the internal portion of a slip joint with the surface (55) of an outside diameter in close proximity to the surface (54) of an inside diameter of the external portion of the slip joint. A coating is formed on either or both adjacent surfaces of the slip joint (54, 55) to produce a seal to block the passage of gas or soot from the exhaust gas to the ambient environment. The internal part of the slip joint and the external part of the slip joint can be juxtaposed. What is important is that the sealing material is applied to the active surfaces of the slip joint and cured prior to joining the parts to form the joint.

In a variation to the third embodiment of the invention, a “C” seal, or sealing ring, which is similar to a metal version of an “O” ring, is included in the slip joint, and a sealing material is applied to the active components of the slip joint (the surfaces of the inner and outer components and the sealing ring) and cured or dried prior to assembly to produce a seal for the exhaust gas and soot which can leak to the ambient environment.

In the fourth embodiment of the invention, sealant is applied to the jointing surfaces of a housing containing a valve, or other like mechanism where said housing is assembled to the turbine housing, and cured or dried prior to assembly. In a manner similar to the pilot and abutment configuration of the bearing housing into the turbine housing, as described above, the “accessory” housing is mounted to the turbine housing with the pre-solidified coating formed on the appropriate, adjacent surfaces of the joint.

In a fifth embodiment of the invention, a sealant is applied to the jointing surfaces between components of the turbocharger and other engine or vehicle components and dried or cured. One example of such a joint is the marmon joint from the exducer of the turbine housing to the vehicle downpipe (the connection from turbocharger to exhaust pipe). Another example of the fifth embodiment of the invention is the connection of the turbocharger turbine housing to the exhaust manifold of the engine.

Now that the invention has been described,

I claim:

1. A method for attaching a turbocharger end housing (2, 5) to a turbocharger bearing housing (3), the method comprising:
(a) identifying complementary contact surfaces between the end housing and the bearing housing,
(b) applying a flow/able sealing material to at least one of said complementary surfaces,
(c) drying or curing the sealing material to form a dried or cured solidified coating, and
(d) assembling the turbocharger such that the coating forms a gas barrier.

2. The method according to claim 1, wherein said end housing is a turbine housing (2).

3. The method according to claim 2, wherein a heat shield (80) is provided between the bearing housing (3) and turbine housing (2), and wherein said complementary contact surfaces are the surfaces at which the heat shield contacts the bearing housing and turbine housing.

4. The method according to claim 3, wherein said sealing material is dried or cured onto the contact surfaces of the heat shield at a temperature above 50° C.

5. The method according to claim 3, wherein said sealing material is dried or cured onto the contact surfaces of the heat shield at a temperature above 100° C.

6. The method according to claim 1, wherein said coating has a thickness of from 0.5 to 1.2 mm.

7. The method according to claim 1, said complementary contact surfaces are the surfaces at which the bearing housing (3) contacts the turbine housing (2), and wherein said sealing material is applied to said bearing housing.

8. The method according to claim 1, said complementary contact surfaces are the surfaces at which the bearing housing (3) contacts the turbine housing (2), and wherein said sealing material is applied to said turbine housing.

9. The method according to claim 1, said complementary contact surfaces are the surfaces at which the bearing housing (3) contacts the compressor housing (2), and wherein said sealing material is applied to said compressor housing or bearing housing.

10. The method according to claim 1, wherein said sealing material is selected from the group consisting of molybdenum disulfide based sealing material, graphite based sealing material, ceramic based sealing material, and fluoropolymer based sealing material.

11. The method according to claim 1, wherein said end housing is joined to said bearing housing by a clamp-plate-and-bolted type connection or a vee-band connection.

12. A method for forming an attachment to a turbocharger end housing (2, 5), the method comprising:
(a) identifying complementary contact surfaces between the end housing and a part to be connected to the end housing,
(b) applying a flowable sealing material to at least one of said complementary surfaces,
(c) drying or curing the sealing material to form a dried or cured solidified coating, and
(d) assembling the turbocharger such that the coating forms a gas barrier between the turbocharger end housing and the part.

13. The method according to claim 12, wherein said end housing is a turbine housing, and wherein said part is a duct connecting said turbine housing to a second turbine housing.

14. The method according to claim 12, wherein the part is a turbine duct carrying the exhaust from an exducer of first turbine to the inlet of a second turbine, and wherein the complementary contact surfaces are designed to form a slip joint.
